(19) United States
(12) Patent Application Publication
(10) Pub. No.: US 2017/0009025 A1
(43) Pub. Date: Jan. 12, 2017

(54) Surfactant Compositions and Methods of Forming and Using Same

(71) Applicant: Cognis IP Management GmbH, Dusseldorf (DE)

(72) Inventors: Ana Maria Fernandez, Chalfont, PA (US); Michael Allen, Greenville, SC (US); Richard Crews, Simpsonville, SC (US); Loubna Jebbanema, King Of Prussia, PA (US)

(21) Appl. No.: 15/272,047

(22) Filed: Sep. 21, 2016

Related U.S. Application Data
(63) Continuation of application No. 12/371,885, filed on Feb. 16, 2009, now abandoned.
Application No. 12/371,885 is a continuation-in-part of application No. 11/869,185, filed on Oct. 9, 2007, now abandoned.
(60) Provisional application No. 60/856,638, filed on Nov. 3, 2006.
(60) Provisional application No. 60/853,344, filed on Oct. 20, 2006.

(51) Int. Cl. C08J 3/09; C08L 71/00; C08L 33/12; C08L 25/14; C09D 5/02; C09D 7/12; C09D 171/00; C09D 133/12; C09D 125/14; C09D 131/04; C08K 5/06; C08L 31/04

(52) U.S. Cl. CPC C08J 3/095; C08K 5/06; C08L 71/00; C08L 33/12; C08L 25/14; C08L 31/04; C09D 7/1241; C09D 7/125; C09D 171/00; C09D 133/12; C09D 125/14; C09D 131/04; C09D 5/024; C08J 2333/12; C08J 2325/14; C08J 2331/04; C08J 2371/00; C08L 2201/56; C08J 2433/12; C08J 2425/14; C08J 2431/04; C08J 2471/00

(57) ABSTRACT

Disclosed are surfactant compositions comprising:
(a) at least one alkoxylated glycol ether; and
(b) at least one compound in accordance with Formula VII;

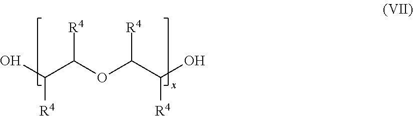

where
x is from about 1 to about 100, and
each R⁴ is independently H or an alkyl moiety having from about 1 to about 2 carbon atoms, provided that the total number of carbon atoms within each x unit is not greater than about 8.

### RELATED APPLICATIONS

The present application is related to and claims the priority benefit of pending U.S. patent application Ser. No. 11/869,185, filed on Oct. 9, 2007, which in turn claims the priority benefit of U.S. Provisional Application No. 60/853,344, filed on Oct. 20, 2006, and from U.S. Provisional Application No. 60/856,638, filed on Nov. 3, 2006, each of which is incorporated herein by reference in its entirety.

### FIELD OF THE INVENTION

The invention relates generally to surfactants, and more particularly to surfactants and methods for forming and using the surfactants. In one particular aspect, the invention is in the field involving emulsion polymerization reactions and polymer dispersions, and for stabilizing emulsion polymers, polymer dispersions, and polymer coatings.

### BACKGROUND

Surfactants are used in wide variety of applications, ranging from use as a component in cosmetics and pharmaceutical preparations to use in connection with chemical reactions, including for example emulsion polymerization reactions.

Emulsion polymers obtained by emulsion polymerization of ethylenically unsaturated monomers are used industrially for architectural coatings, adhesives, paper coatings, and textiles. Anionic surfactants or non-ionic surfactants may be used as emulsifiers for emulsion polymerization reactions. The emulsifier may affect the mechanical, chemical, freezing, and storage stability of an emulsion polymer, in addition to affecting, for example, the polymer particle diameter, viscosity, and foaming characteristics. Additionally, the emulsifier may also affect the water, moisture, and heat resistance, and also the adhesiveness of a polymer film formed from the emulsion polymer.

U.S. Pat. No. 5,958,835—Baker et al. discloses the use of a surfactant package in connection with flowable herbicidal compositions. The surfactant package of Baker et al. contains a combination of an anionic compound based on monosulfuric acid esters and a nonionic compound based on alkyl or alkylphenol glycol ethers. The patent discloses that the composition should contain at least one non-ionic polyglycol ether which comprises ethyleneoxide moieties and optionally propylene oxide moieties. (see col. 2, lines 40-45).

Although surfactant compositions containing alkyleneoxide moieties in general are thus known and may have achieved some level of success, applicants have come to recognize a continuing need for surfactants and methods for using surfactants having improved and advantageous temperature dependent properties, such as liquid/gel phase transition properties. For example, applicants have come to appreciate that an advantage can be achieved if the gel-phase temperature of surfactant compositions in general, and of surfactant concentrates in particular, can be lowered significantly. Such a property will be advantageous, for example, in connection with efforts to flush lines containing the surfactant during and/or after the time that the lines have been exposed to temperatures that would otherwise have produced a gel phase. This is because it is difficult and potentially problematic to remove the gel phase surfactant from such lines by flushing with water, which the commonly used method to clear such lines.

Applicants have thus come to appreciate a need for improved surfactant compositions and related compositions and materials that are potentially useful in numerous applications, including emulsion polymerization and polymer stabilization, while avoiding one or more of the disadvantages of prior compositions and methods.

### SUMMARY

One aspect of the present invention comprises a surfactant composition comprising at least one alkoxylated glycol ether and at least one polyalkyleneglycol having alkylene-derived moities based on ethylene and/or propylene and/or butylene, including substituted and unsubstituted forms thereof, including capped and uncapped forms thereof, and all combinations of each of these.

In certain especially preferred embodiments, the surfactant compositions of the present invention comprise:

(a) at least one alkoxylated glycol ether; and

(b) at least one compound in accordance with Formula VII;

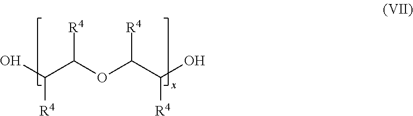

where

x is from about 1 to about 100, more preferably from about 2 to about 75,

each R⁴ is independently H or an alkyl moiety having from about 1 to about 2 carbon atoms, provided that the total number of carbon atoms within each x unit is not greater than about 8. In certain preferred embodiments, x is from about 2 to about 25, more preferably from about 2 to about 15, and preferably in certain embodiments about 7.

In certain aspects of these embodiments of the invention, it is preferred that the value of x in Formula VII is a value such that the one or more compounds in accordance with Formula VII have a weight average molecular weight (Mw) of from about 2500 to about 7500, more preferably from about 3000 to about 6500. For those preferred embodiments in which the Formula VII compounds are predominantly comprised of moieties comprising two carbon atoms, it is preferred that the one or more compounds in accordance with Formula VII have a weight average molecular weight (Mw) of from about 2500 to about 5000, preferably of from about 3500 to about 4500, more preferably about 4000. For those preferred embodiments in which the Formula VII compounds are predominantly comprised of moieties comprising three carbon atom, it is preferred that the one or more compounds in accordance with Formula VII have a weight average molecular weight (Mw) of from about 3500 to about 7500, preferably of from about 5500 to about 6500, more preferably about 6000.

In certain preferred embodiments, the at least one alkoxylated glycol ether compound comprises one or more compounds selected from the group consisting of compounds in accordance with Formula (III), Formula (IV) or combinations of any of these:

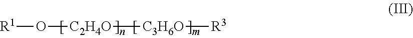

where

R¹ is a saturated or unsaturated, branched aliphatic moiety having from 6 to 22 carbon atoms (hereinafter sometimes referred to for convenience as a “C₆₋₂₂ radical”), preferably with an average branching of about 2 to about 8 per radical,

R³ is H, a substituted or unsubstituted benzyl moiety, or an alkyl moiety having from 1 to 4 carbon atoms,

n represents a value from 0 to about 100, and

m represents a value from 0 to about 100, provided that the sum of n+m is from 1 to about 200, it being understood that the ethoxy and propoxy units when present in a compound in accordance with formula (III) can be present in block and/or a random arrangement and that the values of n and m represent all of the ethoxy and propoxy units respectively in the compound;

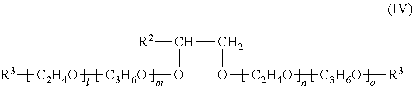

where

R² is a saturated or unsaturated aliphatic moiety having from 8 to 16 carbon atoms (hereinafter sometimes referred to for convenience as a “C₈₋₁₆ radical”),

each R³ is independently H, a substituted or unsubstituted benzyl moiety, or an alkyl moiety having from 1 to 4 carbon atoms, and

each of l, m, n and o represents a value from 0 to about 100, where the sum of I+m+n+o is preferably from 1 to about 200, with the sum of I+m preferably being from about 1 to about 100 and the sum of n+o preferably being from about 1 to about 100, it being understood that the ethoxy and propoxy units when present in a compound in accordance with formula (IV) can be present in block and/or a random arrangement.

According to an aspect of the invention, water may be added to the surfactant concentrate to form a liquid surfactant composition. The surfactant concentrate, or the liquid surfactant composition, may be used, for example, by adding it to an emulsion polymerization reaction or a polymer dispersion, preferably in an amount of from about 0.3% to about 10% by weight, based on the total weight of materials in the emulsion polymerization reaction or in the polymer dispersion.

The present invention thus provides in one aspect emulsion polymerization reaction methods and emulsion polymers and in another aspect methods for forming and/or stabilizing an emulsion polymer, a polymer dispersion and/or a polymer coating formulation. In preferred forms of each of these aspects, the methods including the step of: introducing into an emulsion polymer reaction medium, and/or into a polymer dispersion or emulsion, and/or a surfactant composition, and/or into a polymer coating formulation in accordance with the present invention. Although it is contemplated that the amount of the present surfactant composition to be added to the polymer dispersion and/or reaction medium can vary widely within the scope of the present invention, it is preferred in many embodiments that the present surfactant compositions are present in an amount of from about 0.3% to about 10% by weight, based on the total weight of the reaction medium and/or polymer dispersion.

In certain preferred embodiments, the surfactant composition introduced into the reaction medium and/or the dispersion comprises:

(a) at least one alkoxylated glycol ether; and

(b) at least one compound in accordance with Formula VII;

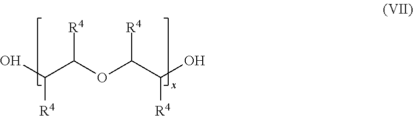

x is from about 1 to about 100, more preferably from about 2 to about 75,

each R⁴ is independently H or an alkyl moiety having from about 1 to about 2 carbon atoms, provided that the total number of carbon atoms within each x unit is not greater than about 8. In certain preferred embodiments, x is from about 2 to about 25, more preferably from about 2 to about 15, and preferably in certain embodiments about 7.

In certain aspects of these embodiments of the invention, it is preferred that the value of x in Formula VII is a value such that the one or more compounds in accordance with Formula VII have a weight average molecular weight (Mw) of from about 2500 to about 7500, more preferably from about 3000 to about 6500. For those preferred embodiments in which the Formula VII compounds are predominantly comprised of moieties comprised of two carbon atoms, it is preferred that the one or more compounds in accordance with Formula VII have a weight average molecular weight (Mw) of from about 2500 to about 5000, preferably of from about 3500 to about 4500, more preferably about 4000. For those preferred embodiments in which the Formula VII compounds are predominantly comprised of moieties having three carbon atoms, it is preferred that the one or more compounds in accordance with Formula VII have a weight average molecular weight (Mw) of from about 3500 to about 7500, preferably of from about 5500 to about 6500, more preferably about 6000.

Of course in certain preferred embodiments of the present invention the alkoxylated glycol ether is selected from the group of compounds consisting of Formula III and Formula IV compounds, as defined above, and combinations of any two or more of these.

### DETAILED DESCRIPTION OF PREFERRED EMBODIMENTS

As used herein, the terms “comprises”, “comprising”, “includes”, “including”, “has”, “having”, or any other variation thereof, mean that other elements or components may be included. For example, a process, method, article, or apparatus that comprises a list of elements is not necessarily limited to the expressly listed elements, but may include other elements inherent, or not expressly listed, to such process, method, article, or apparatus. In addition, unless expressly stated to the contrary, the term “or” refers to an inclusive “or” and not to an exclusive “or”. For example, the condition A “or” B is satisfied by any one of the follow: A is true (included) and B is false (omitted); A is false (omitted) and B is true (included); and both A and B are true (both included).

The terms “a” or “an” are used to describe elements and components of the invention. This is done for convenience to the reader and to provide a general sense of the invention. The use of “a” or “an” should be understood to include one or at least one. In addition, the singular also includes the plural, unless indicated to the contrary. For example, reference to a composition containing “a compound” includes at least one or more compound(s).

### The Compositions

Although it is contemplated that the relative amounts of component (a) compound(s), that is alkoxylated glycol ether, and the component (b) compounds may vary widely within the scope of the present invention, applicants have found that unexpected advantages can be achieved in certain embodiments in which component (b) compounds are present in the compositions in amounts from about 1% to about 50% by weight, more preferably in amounts of from about 1% to about 30% by weight, based on the total of the (a) components and (b) components in the composition.

For certain preferred embodiments, particularly those in which the composition comprises a surfactant concentrate, it is preferred that the at least about 50% by weight of the composition is comprised of the combination of components (a) and (b). In such embodiments, it is contemplated that numerous other compounds and agents can be included in the composition and the presence of all such compounds and agents, in all relative amounts, are within the scope of the present invention. Examples of additional compounds and agents which may be present include biocides.

For compositions in the form of polymer emulsions or polymer dispersions, it is preferred in certain embodiments that the components of such emulsions and dispersion are present in amounts as indicated in the following Table 1, where the wt % is based on the total of the components in the emulsion or dispersion, with all amounts understood to be modified by the word “about.”

TABLE 1

| | Broad | Intermediate | More Preferred |
|---|---|---|---|
| | Range, wt % | Range, wt % | Range, wt % |
| Polymer Dispersion | 85-99.7 | 95-99 | 97-99.5 |
| or Emulsion | | | |
| (including water) | | | |
| Total compounds in | 0.3-15 | 1-5 | 0.5-3 |
| accordance with | | | |
| components (a) and (b) | | | |

In certain preferred embodiments, the compositions of the present invention comprise compound(s) in accordance with component (a), compounds in accordance with component (b), and water. Preferably in such compositions, it is preferred that the composition is in the form of a liquid which is pourable In such embodiments, it is contemplated that all relative amounts of these three components are within the scope of the present invention. In certain preferred embodiments, however, it is preferred that the components are present in amounts as indicated in the following Table 2, where the wt % is based on the total of the three components in the table, with all amounts understood to be modified by the word “about”:

TABLE 2

| | Broad | Intermediate | More Preferred |
|---|---|---|---|
| Component | Range, wt % | Range, wt % | Range, wt % |
| a | 20-90 | 30-80 | 35-75 |
| b | 0.3-30 | 0.4-25 | 0.5-20 |
| water | 10-70 | 20-60 | 30-50 |

The Alkoxylated Glycol Ethers

As mentioned above, the broad scope of the present invention contemplates compositions and methods which use at least one alkoxylated glycol ether in combination with at least one polyalkyleneglycol. At present it is believed that all alkoxylated glycol ethers are adaptable for use in accordance with the present invention in view of the teachings and disclosure contained herein.

According to certain preferred aspects of the invention, however, the alkoxylated glycol ethers used in the surfactant composition, and preferably the Formula III and Formula IV compounds, have an alkoxy content which is, on average, from about 1 to about 100, preferably from about 5 to about 75, more preferably from about 25 to about 75, and even more preferably from about 40 to about 60. As used herein, the term “alkoxy content” means the total number of alkoxy units present per molecule, on average, in the alkoxylated glycol molecules present in the surfactant composition.

For preferred compositions of the present invention comprising at least one Formula (III) compound, the alkoxy content is represented by the average of the values of (m+n) per molecule averaged over all compounds corresponding to Formula (III). In highly preferred compositions comprising Formula (III) compounds, the average value of (m+n) per Formula III molecule in the composition is from 1 to about 100, preferably from about 5 to about 75, more preferably from about 25 to about 75, and even more preferably from about 40 to about 60.

In certain preferred embodiments, the compositions comprise Formula III compounds consisting essentially of one or more compounds in which n is from 1 to about 75, more preferably from about 40 to about 60, and m is from about 0 to about 10, more preferably about 0.

In certain preferred embodiments, R¹ in Formula III compounds has from about 10 to about 15 carbon atoms, and even more preferably 13 carbon atoms, in at least about 30% by weight, even more preferably at least about 50% by weight, and even more preferably at least about 70% by weight of the compounds according to Formula III contained in the composition. In certain preferred embodiments R¹ has from about from about 8 to about 10 carbon atoms in about 1% to about 5% by weight of the compounds according to Formula III contained in the composition. In certain preferred embodiments R¹ has from about from about 13 to about 15 carbon atoms in from about 5% to about 15% by weight of the compounds according to Formula III contained in the composition. In certain highly preferred embodiments, the compounds according to Formula III comprise about 85% by weight of compounds in which R¹ has about 13 carbon atoms, about 2% by weight of compounds in which R¹ has about 9 carbon atoms, about 2% by weight of compounds in which R¹ has about 10 carbon atoms, and about 10% by weight of compounds in which R¹ has about 14 carbon atoms.

In certain preferred embodiments, the composition comprises, and preferably comprises in major proportion by weight, and more preferably at least 70% by weight based on all compounds according to Formula III, compounds in which R¹ is saturated. Furthermore, it is preferred in certain embodiments that the compounds in accordance with formula III have R¹ with, on average, branching of from about 2 to about 8 per radical, more preferably from about 2 to about 4 per radical, and even more preferably from about 2.5 to about 3.5 per radical.

In certain preferred embodiments, the compound in accordance with Formula III, when present, comprises at least one compound according to Formula (IIIA):

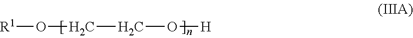

where R¹ and n can have any and all of the values and properties indicated above in connection with Formula III. In highly preferred forms, R¹ in the Formula IIIA compounds is a saturated or unsaturated, C₆₋₂₂ radical, preferably branched, and n represents a value from 1 to about 100.

For preferred compositions of the present invention comprising at least one Formula (IV) compound, the alkoxy content is represented by the sum of (l+m+n+o) per molecule averaged over all compounds corresponding to Formula (IV). In highly preferred compositions comprising Formula (IV) compounds, the average value of (l+m+n+0) per Formula IV molecule in the composition is from 2 to about 200, preferably from about 10 to about 150, more preferably from about 50 to about 125, and even more preferably from about 40 to about 100.

In certain preferred embodiments, the compositions comprise Formula IV compounds in which each of m and o is below about 5, and even more preferably about 0, and (m+n) is from 1 to about 100, preferably from about 5 to about 75, more preferably from about 25 to about 75, and even more preferably from about 40 to about 60. The compounds in which each of m and o is zero are represented by Formula IVA below, which a preferred Formula IV compound in accordance with certain embodiments:

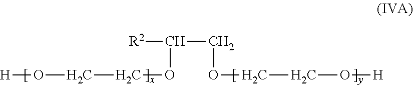

wherein R² is a saturated or unsaturated C₈₋₁₆ radical, and x and y is each independently a value from 0 to 100, wherein the sum of x and y preferably represents a value of at least 1 to about 100. In certain preferred embodiments the sum of x and y are from about 1 to about 75, more preferable from about 40 to about 60, and even more preferably in certain embodiments about 50. In certain preferred embodiments, R² comprises from about 6 to about 14 carbon atoms, and even more preferably about 13 carbon atoms in certain embodiments.

For preferred compositions of the present invention comprising a combination of at least one Formula (III) compound and at least one Formula (IV) compound, the alkoxy content is represented by the sum of the values of (l+m+n+o) per molecule for each compound corresponding to either Formula (III) or Formula (IV). In highly preferred compositions having both Formula (III) and/or Formula (IV) compounds, the average value of (l+m+n+o) per molecule in the composition is from 1 to about 100, preferably from about 5 to about 75, more preferably from about 25 to about 75, and even more preferably from about 40 to about 60.

Formula VII Compounds

As mentioned above, the compositions of the present invention include at least one compound in accordance with Formula VII as defined about. In preferred embodiments, the Formula VII compound of the composition comprises, and in certain embodiments comprise in major proportion by weight (based on the total weight of the Formula VII compounds in the composition), and even more preferably in certain embodiments consist essentially of, oligomers and/or polymers with a molecular mass below about 20,000 g/mol, and even more preferably below about 10,000. Compounds in accordance with Formula VII are generally known and can be prepared by know methods, including for example by polymerization of alkylene oxide, such as ethylene oxide. Preferred in many embodiments are polyalkyleneglycols which are formed by a reaction initiated by methyl ether (mPAGs). Branched and star compounds are within the scope of Formula VII.

In certain preferred embodiments, the compositions of the invention comprise component (a) having at least one compound in accordance with Formula III and at least one compound in accordance with Formula (IV), and for such embodiments it is generally preferred that the compositions have such components in the relative range of concentrations indicated below in Table 3, where the wt % is based on the total of the three components in the table, with all amounts understood to be modified by the word “about”:

TABLE 3

| | Broad | Intermediate | More Preferred |
|---|---|---|---|
| Component | Range, wt % | Range, wt % | Range, wt % |
| a - Formula III | 10-98 | 15-95 | 20-90 |
| a - Formula IV | 1-90 | 5-85 | 10-80 |
| b | 1-30 | 2-30 | 5-20 |

The surfactant concentrate may be added to water to form a pourable, liquid surfactant composition.

### Methods of Making the Composition

One preferred method for making the surfactant concentrate comprises the steps of: (a) providing at least one alcohol according to general formula (I):

R¹—OH (I)

wherein R¹ represents a saturated or unsaturated, branched C₆₋₂₂ radical with an average branching of from about 2 to about 8 per radical;
(b) providing at least one diol according to general formula (II):

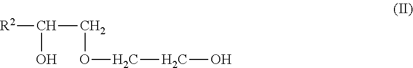

wherein R² represents a saturated or unsaturated C₈₋₁₆ radical;
(c) combining compound (I) and compound (II) to form a mixture; and
(d) ethoxylating the mixture to obtain a reaction product, comprising at least one compound in accordance with Formula (III) and/or at least one compound in accordance with Formula (IV):

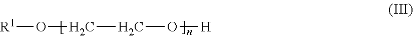

wherein R¹ is as defined above, and wherein n represents a value from 0 to about 100;
a compound according to general formula (IV):

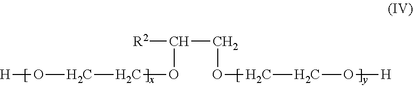

wherein R² is as defined above, x and y each represent a value from 0 to 100, and wherein the sum of x and y represents a value of at least 1 to 100, and at least one compound in accordance with Formula (VII)

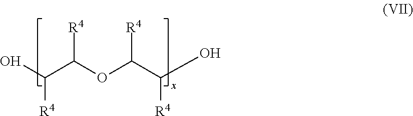

where

x is from about 1 to about 100, more preferably from about 2 to about 75,

each R⁴ is independently H or an alkyl moiety having from about 1 to about 2 carbon atoms, provided that the total number of carbon atoms within each x unit is not greater than about 8. In certain preferred embodiments, x is from about 2 to about 25, more preferably from about 2 to about 15, and preferably in certain embodiments about 7.

According to certain preferred embodiments, step (d) is conducted at a temperature of from about 100° C. to about 180° C., and at a pressure of not greater than about 70 psi. An alkali catalyst may be added in step (d).

The surfactant concentrate, which includes at least one compound corresponding to general Formula (III) and/or Formula (IV) and at least one compound corresponding to general formula (VII), is thus made by certain preferred embodiments by coalkoxylation (substantially simultaneous alkoxylation) of a mixture of compounds corresponding to general formulas (I) and (II). At least one of the alcohol compounds according to general formula (I) in the coalkoxylation process is preferably branched. When present, as is preferred, branching may occur at any position on the carbon chain of the alcohol. For example, a suitable average branching ranges between about 2 to about 8 per radical. In another embodiment, the average branching may range between about 2 to about 4, and in another embodiment, the average branching may range between about 2.5 to about 3.5 per radical. It should be understood that a suitable compound according to general formula (I) may include a mixture of one or more branched alcohols with varying amounts of branching per radical.

A suitable branched alcohol according to formula (I) includes, but is not limited to, tridecyl alcohol, octylphenol, nonylphenol, or dodecylphenol. A suitable tridecyl alcohol is available from ExxonMobil Chemical Company under the trademark EXXAL® (EXXAL®13), or from Sasol under the trademark SAFOL® (SAFOL®23). Other suitable branched alcohols are available from ExxonMobil under the trademark EXXAL®. Suitable branched alcohols, including octylphenol, nonylphenol and dodecylphenol, are also available from Schenectady International, Inc., in New York. Suitable branched alcohols according to general formula (I) also include, but are not limited to, branched alcohols available under the trademark NEODOL®, from Shell Chemical Company in Texas.

In addition to at least one branched alcohol according to formula (I), a compound according to general formula (II) is included in the coalkoxylation process. Suitable compounds according to general formula (II) include linear, even or odd numbered, primary or secondary, fatty or synthetic alcohols. Suitable compounds according to general formula (II) are commercially readily available, for example, from Cognis Corporation, of Ohio. A suitable secondary alcohol according to general formula (II) includes β-2-hydroxyethoxy alcohol, but is not limited thereto.

Compounds according to general formulas (I) and (II) are preferably mixed, in a suitable vessel, prior to coalkoxylation. During coalkoxylation, the mixture is preferably subjected to elevated temperatures ranging between about 100° C. to about 180° C., at a maximum pressure of about 70 psi. The process of coalkoxylation is preferably carried out in the presence of suitable catalysts, including sodium hydroxide (NaOH) or potassium hydroxide (KOH). Sodium ethylate or sodium methylate may also be used, but the reaction-produces unwanted by-products, including ethanol and methanol.

According to another aspect of the invention, in another embodiment, a pourable, liquid surfactant composition includes the surfactant concentrate in water. A selected quantity of water may be added, under agitation, to the surfactant concentrate, preferably at a temperature ranging from about 25° C. to about 80° C. to form a liquid surfactant composition. The liquid surfactant composition may be cooled and water may be added to replace any water lost during the conversion. The surfactant concentrate may be present in the liquid surfactant composition in an amount of from about 30% to about 90% by weight, based on the total weight of the liquid surfactant composition, wherein the amounts by weight total 100%. The surfactant concentrate may be present in the liquid surfactant composition in an amount of from about 40% to about 85% by weight, based on the total weight of the liquid surfactant composition. The surfactant concentrate may also be present in the liquid surfactant composition an amount of from about 50% to about 80% by weight, based on the total weight of the liquid surfactant composition. The solidification point of the liquid surfactant composition is preferably less than about 15° C., and the solidification point is preferably also less than about 0° C. The liquid surfactant composition may have a viscosity at 25° C. of less than about 2000 cps, and even more preferably less than about 1000 cps. The difference in solidification points and viscosities depends, in one aspect, upon the selected ratios of compounds according to general formulas (III), (IV) and (VI).

In another embodiment of the invention, the compounds according to general Formulas III and/or IV are reacted with a suitable reactant, for example, methyl chloride, butyl chloride, or benzyl chloride, resulting in one or more terminal hydrogen group on each compound according to general formulas (III) and (IV) being capped with a methyl, butyl, or benzyl group.

According to another aspect of the invention, a method for stabilizing an emulsion polymer or a polymer dispersion comprises the step of: adding, to an emulsion polymer or a polymer dispersion, from about 0.3% to about 10% by weight, based on the total weight of a reaction product, a composition in accordance with the present invention

According to an aspect of the invention, the above-described components (a) and (b) may be in the form of a surfactant concentrate or a pourable, liquid surfactant composition. Alternatively, from about 0.5% to about 5% by weight, based on the total weight of the reaction product, may be added to an aqueous emulsion polymer or polymer dispersion. Alternatively, from about 0.5% to about 1% by weight, based on the total weight of the reaction product, may be added to an aqueous emulsion polymer or polymer dispersion.

Advantageously, in the emulsion polymerization reaction of ethylenically unsaturated monomers, the surfactant concentrate or liquid surfactant composition may be added to an emulsion polymerization reaction to carry out the polymerization reaction. In an emulsion polymerization reaction or polymer dispersion, the surfactant concentrate or liquid surfactant composition may be added in amounts from about 0.3% to about 10% by weight, based on the total weight in the emulsion polymerization reaction or polymer dispersion. Alternatively, from about 0.5% to about 6% by weight of the surfactant concentrate or liquid surfactant composition, based on the total weight in the emulsion polymerization reaction or polymer dispersion, may be added. Alternatively, from about 1% to about 3% by weight of the surfactant concentrate or liquid surfactant composition may be added, based on the total weight in the emulsion polymerization reaction or polymer dispersion.

Suitable ethylenically unsaturated monomers include, but are not limited to C₁₋₁₂ alkyl acrylates, including, but not limited to n-butyl acrylate, 2-ethylhexyl acrylate, and mixtures thereof; C₁₋₁₂alkyl methacrylates including, but not limited to ethyl (meth)acrylate, methyl (meth)acrylate, n-butyl methacrylate, isobutyl methacrylate, t-butyl methacrylate, and mixtures thereof; vinylaromatic compounds including, but not limited to styrene, α-methylstyrene, 3- and 4-vinyltoluene, and mixtures thereof; ethylenically unsaturated carboxylic acids including, but not limited to C₃₋₆ α,β-monoethylenically unsaturated mono- and dicarboxylic acids, for example, acrylic acid, methacrylic acid, maleic acid, fumaric acid, itaconic acid, and mixtures thereof; and unsaturated carboxamides, including, but not limited to acrylamide, methacrylamide, 2-acrylamide-2-methylpropanesulfonic acid, N-methylolacrylamide, N-methylolmeth-acrylamide, and mixtures thereof. Other examples of ethylenically unsaturated monomers include aliphatic vinyl esters, for example, vinyl acetate, vinyl propionate, vinyl butyrate and isobutyrate, vinyl valerate, vinyl caproate, and mixtures thereof.

The adducts of ethylene oxide with linear fatty alcohols exhibit limited water miscibility, very high viscosities, and high solidification temperatures. Advantageously, the pourable, liquid non-ionic surfactants according to an aspect of the invention have enhanced water miscibility, lower viscosities, lower solidification temperatures, and enhanced surface activity. The surfactant concentrates and liquid compositions advantageously provide for improved solubility and performance in aqueous coating compositions, including, for example, paint formulations.

Advantageously, according to an aspect of the invention, the surfactant concentrates and liquid compositions have low freezing (solidification) points, without the need for adding an anti-freezing agent. In one aspect of the invention, the concentrate has a solidification point (SP) below 15° C., in another aspect, an SP below 5° C., and in another aspect, an SP below 0° C. The difference in solidification points depends, in one aspect, upon the selected ratios of compounds according to general formulas (III), (IV) and (VII).

Waterborne polymer compositions containing the surfactant concentrate or the liquid surfactant composition may be used in a variety of coating applications, including, for example, paints, inks, sealants, and adhesives. The surfactant concentrates and liquid surfactant compositions are also suitable for use in formulations for coating metal, wood, plastic, paper, and textiles. The surfactants and liquid surfactant compositions may also be used in other applications, including for example, home and personal care chemical products, including detergents and cleaning formulations.

The liquid surfactant composition may also be advantageously used for post-polymerization stabilization of latex formulations with high filler content, for example, inorganic fillers containing divalent metallic ions, including calcium, magnesium, and zinc that are conventionally used in traffic paints, paper coatings, and architectural coatings.

The surfactant concentrate and liquid surfactant composition may include a biocide to prevent microbial growth, and other components that do not materially affect the basic characteristics and efficacy of the composition.

Unless otherwise defined, all technical and scientific terms used herein have the same meaning as commonly understood by one of ordinary skill in the art to which the invention belongs. Although methods and materials similar or equivalent to those described herein can be used in the practice or testing of the invention, suitable methods and materials are described below. The materials, methods and examples disclosed herein are illustrative only, and are not intended to be limiting.

### EXAMPLES

### Example 1

### Production of Surfactant Mixtures (Concentrates)

Component A, a predominantly C₁₃ primary saturated branched alcohol, was mixed with Component B (prepared by the ring-opening of a terminally epoxidized C₁₂/C₁₄ alkane mixture (67% by weight C₁₂ and approximately 33% by weight C₁₄) with equimolar quantities of ethylene glycol based on epoxy content). The mixture of Components A and B was reacted with various molar quantities of ethylene oxide.

### Example 2

Component C, a linear fatty alcohol mixture coning about 0% to about 2% by weight n-decanol, about 70% to about 75% by weight of lauric alcohol (C₁₂), about 24% to about 30% by weight myristic alcohol (C₁₄) and about 0% to 2% by weight cetyl alcohol (C₁₆), was mixed with Component B of Example 1. The mixture of Components B and C was reacted with various molar quantities of ethylene oxide.

### Example 3

3.1 Nonylphenol (Component D) was mixed with Component B. The mixture of Components B and D was reacted with various molar quantities of ethylene oxide.

3.2 Octyl phenol (Component E) was mixed with Component B. The mixture of Components B and E was reacted with various molar quantities of ethylene oxide

3.3 A synthetic alcohol mixture containing 67% by weight of a primary C₁₃ alcohol and 33% of a C₁₅ alcohol (Component F) was mixed with Component B. The mixture of Components B and F was reacted with various molar quantities of ethylene oxide.

### Example 4

The surfactant mixtures thus obtained were converted, with water at temperatures of 40° C. to 70° C., into liquid surfactant compositions, which differed in their total surfactant content and in the composition of the surfactant mixtures. Water was added to a selected quantity of surfactant concentrate, sufficient to give 100 grams of liquid surfactant composition. After cooling to room temperature, any water lost during the conversion was replaced.

Table 4 illustrates the surfactant concentrates obtained by ethoxylation of the mixtures of Examples 1 and 2, reacted with different levels of ethylene oxide. In the notation M/A/B:X° C., M represents parts by weight of a surfactant concentrate (a mixture consisting of “A” parts of Component A according to general formula (III), and “B” parts of Component B according to general formula (IV), the sum of A and B equal to 100) in water, and X° C. is the temperature of solidification. For example, the values 50/90/10 represent 50% of the surfactant concentrate in water (50% by weight), and 90/10 represent the amounts of each Component (A and B) present in the mixture, or, for example, the values 60/70/30 represent 60% of the surfactant concentrate in water, where 40% by weight of the total composition is water.

| Example 4 containing surfactant | | | Example 4 containing surfactant | | |
|---|---|---|---|---|---|
| mixtures according to | | | mixtures according to | | |
| Example 1 @ 40EO | | | Example 2 @ 30EO | | |
| M/A/B | X° C. | | M/A/B | X° C. | |
| 50/90/10 | −6° | C. | 60/50/50 | <6° | C. |
| 50/80/20 | −10° | C. | 50/90/10 | 14° | C. |
| 50/70/30 | −12° | C. | 50/90/10\grave{ } | 14° | C. |
| 60/70/30 | −1° | C. | | | |
| 60/67/33 | −2° | C. | | | |
| 75/80/20 | −6° | C. | | | |
| 75/90/10 | −4° | C. | | | |

As illustrated in Table 4, the fatty alcohols of Example 2 had significantly higher solidification points than those of Example 1 according to an aspect of the invention.

### Example 5

Various non-ionic surfactants according to Example 4 (prepared according to Example 1) were evaluated as suitable emulsifiers for emulsion polymerization. The several monomer compositions evaluated were (1) 51% methyl methacrylate/49% butyl acrylate/1% methacrylic acid; (2) 50% styrene/49% butyl acrylate/1% methacrylic acid; and (3) 80% vinyl acetate/19% butyl acrylate/1% methacrylic acid.

The amount of coagulum formed is a measure of the degree of mechanical stability of the latexes. It was found that the amount of coagulum formed using the surfactants listed in Example 4 (prepared according to Example 1) was similar or significantly less than the amount of coagulum formed in latexes made with alkyl phenol surfactants (prepared according to Example 2) with a similar level of ethoxylation as illustrated in Example 4. The results demonstrate that the surfactant concentrates according to the invention are suitable for use in commercial emulsion polymerizations for acrylic copolymers, vinyl acetate copolymers, vinyl neonate copolymers, and styrene copolymers.

### Example 6

Post polymerization stabilization is important for latex formulations with high filler content (for example, inorganic fillers containing divalent metallic ions, including calcium, magnesium, and zinc) conventionally used in application for traffic paints, paper coatings, architectural coatings, and in general highly formulated coatings. The highly ethoxylated (high hydrophilic-lipophilic balance (HLB) values) of the surfactants of Example 4 containing the surfactants in water according to Example 2 have indicated excellent performance as post polymerization emulsifiers for improving the electrostatic stability of latexes, including acrylic copolymers, for improving the electrostatic stability of latexes, including acrylic copolymers, styrene copolymers, vinyl acetate copolymers and styrene butadiene copolymers. Therefore, it is inferred that the surfactants of Example 4, containing surfactant mixtures according to Example 1, have equally similar, if not improved, performance characteristics.

### Example 7

Component A, a predominantly C₁₃ primary saturated branched alcohol was mixed with Component B, prepared by the ring-opening of a terminally epoxidized C₁₂/C₁₄ alkane mixture (67% by weight C₁₂ and approximately 33% by weight C₁₄) with equimolar quantities of ethylene glycol based on epoxy content. The mixture of Components A and B was reacted with various molar quantities of ethylene oxide. The final mixture containing alkyl ethoxylates of formulas (III) and (IV) and from about 1% to about 30% of polyethylene glycol.

### Example 8

Component A, a predominantly C₁₃ primary saturated branched alcohol was mixed with Component B, prepared by the ring-opening of a terminally epoxidized C₁₂/C₁₄ alkane mixture (67% by weight C₁₂ and approximately 33% by weight C₁₄) with equimolar quantities of ethylene glycol based on epoxy content. The mixture of Components A and B was reacted with various molar quantities of propylene oxide. The final mixture containing alkyl ethoxylates of formulas (III) and (IV) and from about 1% to about 30% by weight of polypropylene glycol and polyethylene glycol.

### Example 9

Component A, a predominantly C₁₃ primary saturated branched alcohol was mixed with Component B, prepared by the ring-opening of a terminally epoxidized C₁₂/C₁₄ alkane mixture (67% by weight C₁₂ and approximately 33% by weight C₁₄) with equimolar quantities of ethylene glycol based on epoxy content. The mixture of Components A and B was reacted in a known manner with various molar quantities of ethylene oxide and propylene oxide as to obtain different block arrangements and lenghs . . . . The final mixture containing alkyl ethoxylates of formulas (III) and (IV) and from about 1% to about 30% by weight of polypropylene glycol and polyethylene glycol.

### Example 10

Component C, a fatty alcohol mixture containing about 0% to about 2% by weight n-decanol, about 70% to about 75% by weight of lauric alcohol (C₁₂), about 24% to about 30% by weight myristic alcohol (C₁₄) and about 0% to about 2% by weight cetyl alcohol (C₁₆) were mixed with component B of Example 7. The mixture of components B and C was reacted with various molar quantities of ethylene oxide. The final mixture containing alkyl ethoxylates of formulas (III) and (IV) and from about 1% to 30% by weight of polyethylene glycol.

### Example 11

Component C, a fatty alcohol mixture containing about 0% to about 2% by weight n-decanol, about 70% to about 75% by weight of lauric alcohol (C₁₂), about 24% to about 30% by weight myristic alcohol (C₁₄) and about 0% to 2% by weight cetyl alcohol (C₁₆) were mixed with component B of Example 1. The mixture of components B and C was reacted with various molar quantities of propylene oxide. The final mixture containing alkyl ethoxylates of formulas (III) and (IV) and from about 2% to about 30% by weight of polypropylene glycol.

### Example 12

Component C, a fatty alcohol mixture containing about 0% to about 2% by weight n-decanol, about 70% to about 75% by weight of lauric alcohol (C₁₂), about 24% to about 30% by weight myristic alcohol (C₁₄) and about 0% to 2% by weight cetyl alcohol (Cm) were mixed with component B of Example 7. The mixture of components B and C was reacted with various molar quantities of ethylene oxide and propylene oxide. The final mixture containing alkyl ethoxylates of formulas (III) and (IV) and from about 2% to 30% by weight of polyethylene glycol and polypropylene glycol.

### Example 13

The surfactants in additional examples 7-12 were formulated into coatings providing excellent freeze-thaw stability. Architectural coatings for flat, semi gloss and gloss applications formulated with surfactants described in additional examples 7, 8, 9, 10, 11, and 12 exhibited excellent freeze thaw, as well as acceptable general properties associated with architectural coatings of gloss, low foaming, scrub cycles and overall stability.

### Example 14

Various nonionic surfactants were evaluated as suitable emulsifiers for emulsion polymerization. The several monomer compositions evaluated are:

51% methylmethacrylate, 49% butyl acrylate, 1% methacrylic acid;

50% styrene, 49% butyl acrylate and 1% metahcrylic acid; and

80% vinyl acetate, 19% butyl acrylate and 1% methacrylic acid, with all amounts in percentage by weight. The amount of coagulum formed is a measure of the degree of mechanical stability of the latexes. It was found that the amount of coagulum formed using the surfactants listed in additional examples 7-12 were similar or significantly less than the amount of coagulum formed in latexes made with alkyl phenols surfactants with similar ethoxylation level. The results show that the surfactants concentrates made according with this invention are suitable surfactants to use in commercial emulsion polymerizations of acrylic copolymers, vinyl acetate copolymers, vinyl neonate copolymers, and styrene copolymers.

### Example 15

High HLB (high ethoxylation level) surfactants of additional examples 7-12 have excellent performance as post polymerization emulsifiers to improve the electrostatic stability of latexes including acrylic copolymers, styrene copolymers, vinyl acetate copolymers and styrene butadiene copolymers. Post polymerization stabilization is important for latexes formulations with high filler content, e.g. inorganic fillers containing divalent metallic ions such as calcium, magnesium, zinc, etc, used for applications in traffic paints, paper coatings, architectural coatings, and in general highly formulated coatings.

The invention has been described with reference to specific embodiments. One of ordinary skill in the art, however, appreciates that various modifications and changes can be made without departing from the scope of the invention as set forth in the claims. For example, although the examples used certain branched alcohols, other branched alcohols may be suitable for the surfactant concentrates and liquid surfactant compositions according to the invention. In addition, although exemplary monomers are described, there is a multitude of monomers, polymer dispersions, and emulsion polymers suitable for use according to an aspect of the invention. Accordingly, the specification is to be regarded in an illustrative manner, rather than with a restrictive view, and all such modifications are intended to be included within the scope of the invention.

Benefits, advantages, and solutions to problems have been described above with regard to specific embodiments. The benefits, advantages, and solutions to problems, and any element(s) that may cause any benefit, advantage, or solution to occur or become more pronounced, are not to be construed as a critical, required, or an essential feature or element of any or all of the claims.

1.-20. (canceled)

21. A method of forming an emulsion polymer, stabilizing an emulsion polymer, a polymer dispersion, or a polymer coating formulation comprising introducing a surfactant composition into an emulsion polymer reaction medium, a polymer dispersion, a polymer emulsion, or a polymer coating formulation, in an amount of from about 0.3% to about 10% by weight, based on the total weight of the polymer reaction medium, polymer dispersion, polymer emulsion, or polymer coating formulation, wherein the surfactant composition comprises
(a) from about 20% to about 95%, by weight of the surfactant composition, of one or more compound in accordance with Formula III 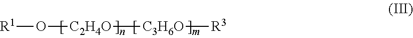
where R¹ is a saturated or unsaturated, branched aliphatic moiety having from 6 to 22 carbon atoms and an average branching of from about 2 to about 8 per radical, R³ is H, or an alkyl moiety having from 1 to 4 carbon atoms, n represents a value from 0 to about 100, and m represents a value from 0 to about 100, provided that the sum of n+m is from 1 to about 200,
and one or more compound in accordance with Formula IV 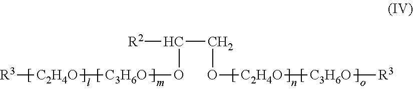
where R² is a saturated or unsaturated aliphatic moiety having from 8 to 16 carbon atoms, each R³ is independently H or an alkyl moiety having from 1 to 4 carbon atoms, and each of l, m, n, and o represents a value from 0 to about 100; and
(b) from about 0.3% to about 40%, by weight of the surfactant composition, of at least one compound in accordance with Formula VII 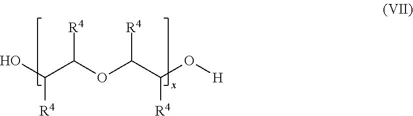
where x is from about 2 to about 75, and each R⁴ is independently H or an alkyl moiety having 1 or 2 carbon atoms, provided that the total number of carbon atoms within each x unit is not greater than about 8.

22. The method of claim 21 wherein at least 3 of said R⁴ in each of said x groups is H.

23. The method of claim 21 wherein x is 7.

24. The method of claim 21 wherein the at least one compound in accordance with Formula VII has a weight average molecular weight (Mw) of from about 3000 to about 6500

25. The method of claim 21 wherein said at least one compound in accordance with Formula (VII) is present in the surfactant composition in an amount of from about 10% to about 30% by weight based on the total of the (a) components and (b) component in the surfactant composition.

26. The method of claim 21, wherein the surfactant composition has a solidification point below 15° C.

27. The method of claim 21, wherein the surfactant composition decreases the amount of coagulum formed during an emulsion polymerization.

28. The method of claim 21, wherein the surfactant composition stabilizes a latex after polymerization.

29. A method of preparing a surfactant concentrate comprising
(a) providing at least one alcohol according to general formula (I):
R¹—OH (I)
wherein R¹ represents a saturated or unsaturated, branched C₆₋₂₂ radical having an average branching of from about 2 to about 8 per radical;
(b) providing at least one diol according to general formula (II): 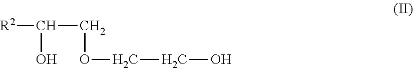
wherein R² represents a saturated or unsaturated C8-16 radical;
(c) combining alcohol (I) and diol (II) to form a mixture; and
(d) ethyoxylating the resulting mixture to obtain a reaction product comprising (i) at least one compound in accordance with Formula (III): 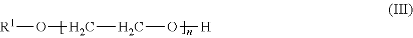
wherein R¹ is as defined above, and wherein n represents a value from 0 to about 100; (ii) at least one compound in accordance with Formula (IV): 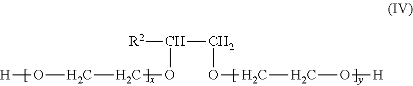
wherein R² is as defined above, x and y each represent a value from 0 to 100, and wherein the sum of x and y represents a value of at least 1 to 100, and (iii) at least one compound in accordance with Formula (VII): 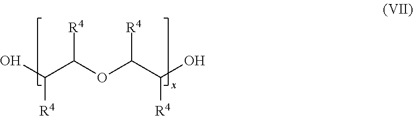
where
x is from 1 to about 75,
each R⁴ is independently H or an alkyl moiety having from for 2 carbon atoms, provided that the total number of carbon atoms within each x unit is not greater than about 8.

30. The method according to claim 29 wherein x is from about 2 to about 2.5.

31. A surfactant composition prepared according to the method of claim 29.

32. The surfactant composition of claim 31 wherein compound (VII) is present in an amount of about 1% to about 30%, by weight, of the surfactant concentrate.
